(19) United States
(12) Patent Application Publication
(10) Pub. No.: US 2026/0075173 A1
(43) Pub. Date: Mar. 12, 2026

(54) CONTROL METHOD, PROJECTION APPARATUS, AND NON-TRANSITORY COMPUTER-READABLE STORAGE MEDIUM STORING PROGRAM

(71) Applicant: SEIKO EPSON CORPORATION, Tokyo (JP)

(72) Inventors: Shinpei SHINOHARA, MATSUMOTO-SHI (JP); Kota TAKEUCHI, AZUMINO-SHI (JP)

(21) Appl. No.: 19/319,126

(22) Filed: Sep. 4, 2025

(30) Foreign Application Priority Data
Sep. 6, 2024 (JP) 2024-153939

(51) Int. Cl. H04N 9/31; G06T 7/13

(52) U.S. Cl. CPC H04N 9/3185; G06T 7/13; H04N 9/3155

(57) ABSTRACT

A projection apparatus includes a projector configured to project an image onto a projection surface, a processing device, and a camera. In a first period, the processing device causes the projector to project a first pattern in which the brightness continuously decreases in a first direction that is a direction from the center of the projection surface toward an edge of the projection surface. The processing device causes the camera to capture the image of the projection surface and the first pattern projected onto the projection surface in the first period to acquire a first captured image. Then, the processing device detects a plurality of first feature points indicating edges of the projection surface in the first captured image.

The present application is based on, and claims priority from JP Application Serial Number 2024-153939, filed September 6, 2024, the disclosure of which is hereby incorporated by reference herein in its entirety.

### BACKGROUND

### 1. Technical Field

The present disclosure relates to a control method, a projection apparatus, and a non-transitory-computer-readable storage medium storing a program.

### 2. Related Art

JP-A-2022-92169 discloses a technique of maintaining a positional relationship between a projection surface 90 and a projection image PJIM at a preset initial positional relationship without using a marker or the like indicating the position of the projection surface. In the technique disclosed in JP-A-2022-92169, a first captured image IM1 including a first projection image PJIM1 and the projection surface 90 is acquired by an imaging device 141 in a first period. Four first projection points FPP that are four corners of the first projection image PJIM1 and four first feature points Fa10 to Fa13 serving as feature points of the projection surface 90 are extracted from the first captured image IM1. In a second period later than the first period, a second captured image IM2 including a second projection image PJIM2 and the projection surface 90 is acquired by the imaging device 141. Four second projection points SPP that are four corners of the second projection image PJIM2 and four second feature points Fb10 to Fb13 corresponding to the four first feature points Fa10 to Fa13 in a one-to-one relation are extracted from the second captured image IM2. The four first projection points FPP, the four first feature points Fa10 to Fa13, the four second projection points SPP, and the four second feature points Fb10 to Fb13 in JP-A-2022-92169 are used to, for example, return the positional relationship between the projection surface 90 and the projection image PJIM to the initial positional relationship before a device main body 19 moves, for example, in the first period.

JP-A-2022-92169 is an example of the related art.

In order to improve the accuracy of extracting the four first feature points Fa10 to Fa13 from the first captured image IM1, for example, it is conceivable to project white light to a region including an edge of the projection surface 90 to increase the brightness in the vicinity of the edge. However, the accuracy of extracting the four first feature points Fa10 to Fa13 from the first captured image IM1 sometimes decreases to the contrary because of the influence of secondary reflection of the white light from an object present around the projection surface 90.

### SUMMARY

According to an aspect of the present disclosure, there is provided a control method for a projection system including a projector configured to project an image onto a projection surface, a camera, and one or a plurality of processors configured to control the projector and the camera, the control method executing, with the one or the plurality of processors: causing, in a first period, the projector to project, onto the projection surface, a first pattern in which brightness decreases continuously or stepwise in a direction from a center of the projection surface toward an edge of the projection surface; acquiring a first captured image by causing the camera to capture the projection surface and the first pattern projected onto the projection surface in the first period; and detecting a plurality of first feature points indicating edges of the projection surface in the first captured image.

According to another aspect of the present disclosure, there is provided a control method for a projection system including a projector configured to project an image onto a projection surface, a camera, and one or a plurality of processors configured to control the projector and the camera, the control method executing, with the one or the plurality of processors: causing, in a first period, the projector to project, onto the projection surface, a first pattern in which brightness increases continuously or stepwise in a direction from a center of the projection surface toward an edge of the projection surface, the first pattern being annular and disposed on an outer side of the image; acquiring a first captured image by causing the camera to capture the projection surface and the first pattern projected onto the projection surface in the first period; and detecting a plurality of first feature points indicating edges of the projection surface in the first captured image.

According to an aspect of the present disclosure, there is provided a projection apparatus including: a projector configured to project an image onto a projection surface; and one or a plurality of processors, the one or the plurality of processors executing: causing, in a first period, the projector to project, onto the projection surface, a first pattern in which brightness decreases continuously or stepwise in a first direction that is a direction from a center of the projection surface toward an edge of the projection surface; causing a camera to capture the image of the projection surface and the first pattern projected onto the projection surface in the first period to acquire a first captured image; and detecting a plurality of first feature points indicating edges of the projection surface in the first captured image.

According to another aspect of the present disclosure, there is provided a projection apparatus including: a projector configured to project an image onto a projection surface; and one or a plurality of processors, the one or the plurality of processors executing: causing, in a first period, the projector to project, onto the projection surface, a first pattern in which brightness increases continuously or stepwise in a direction from a center of the projection surface toward an edge of the projection surface, the first pattern being annular and disposed on an outer side of the image; causing a camera to capture the image of the projection surface and the first pattern projected onto the projection surface in the first period to acquire a first captured image, and detecting a plurality of first feature points indicating edges of the projection surface in the first captured image.

According to an aspect of the present disclosure, there is provided a non-transitory computer-readable storage medium storing a program, the program causing a computer, which controls a projector configured to project an image onto a projection surface and a camera, to execute: causing, in a first period, the projector to project, onto the projection surface, a first pattern in which brightness decreases continuously or stepwise in a first direction that is a direction from a center of the projection surface toward an edge of the projection surface; acquiring a first captured image by causing the camera to capture the projection surface and the first pattern projected onto the projection surface in the first period; and detecting a plurality of first feature points indicating edges of the projection surface in the first captured image.

According to another aspect of the present disclosure, there is provided a non-transitory computer-readable storage medium storing a program, the program causing a computer, which controls a projector configured to project an image onto a projection surface and a camera, to execute: causing, in a first period, the projector to project, onto the projection surface, a first pattern in which brightness increases continuously or stepwise in a direction from a center of the projection surface toward an edge of the projection surface, the first pattern being annular and provided on an outer side of the image; acquiring a first captured image by causing the camera to capture the projection surface and the first pattern projected onto the projection surface in the first period; and detecting a plurality of first feature points indicating edges of the projection surface in the first captured image.

### BRIEF DESCRIPTION OF THE DRAWINGS

FIG. 1 is a diagram illustrating a configuration example of a projection apparatus according to an embodiment of the present disclosure.

FIG. 2 is a diagram illustrating an installation example of a projection surface in the embodiment.

FIG. 3 is a diagram illustrating a first pattern in the embodiment.

FIG. 4 is a diagram illustrating an example of a gradient of brightness in a second portion of the first pattern.

FIG. 5 is a diagram illustrating the influence of reflected light from another surface near the projection surface.

FIG. 6 is a flowchart illustrating a flow of processing in a control method executed by a processing device according to a program.

FIG. 7 is a diagram illustrating an example of a first pattern projected by the projection apparatus in the second embodiment.

FIG. 8 is a diagram illustrating an example of a gradient of brightness in a second portion.

FIG. 9 is a diagram illustrating an example of a gradient of brightness in the second portion of the first pattern in a modification (1).

FIG. 10 is a diagram illustrating an example of a first pattern in a modification (2).

### DESCRIPTION OF EMBODIMENTS

Various technically preferable limitations are added to embodiments explained below. However, embodiments of the present disclosure are not limited to the embodiments explained below.

### A. First Embodiment

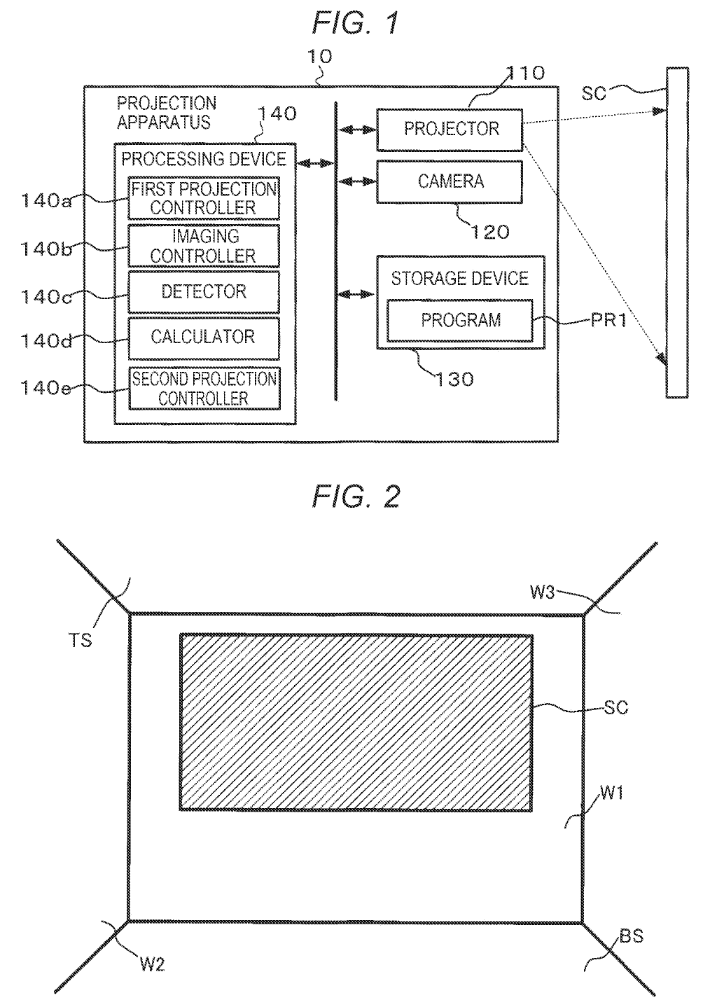

FIG. 1 is a diagram illustrating an example of a configuration of a projection apparatus 10 according to an embodiment of the present disclosure. The projection apparatus 10 is an apparatus that projects an image onto a projection surface SC. As illustrated in FIG. 2, the projection surface SC is installed on a wall W1 of a room in which the projection apparatus 10 is disposed. As illustrated in FIG. 2, a ceiling TS, a floor surface BS, a wall W2, and a wall W3 that partition the room are connected to the wall W1, and the projection surface SC is installed near the ceiling TS. As illustrated in FIG. 1, the projection apparatus 10 includes a projector 110, a camera 120, a storage device 130, and a processing device 140. Each of the projector 110, the camera 120, and the storage device 130 is connected to the processing device 140 via a bus (not illustrated in FIG. 1). The camera 120 may be separate from the projection apparatus 10. The number of projection apparatuses 10 may be one or may be two or more. When the number of projection apparatuses 10 is two or more, multi-projection in which images projected from the projection apparatuses 10 are projected in tiling, stacking, or a combination thereof may be adopted. The following description can also be applied to the case of the multi-projection.

The processing device 140 includes one or a plurality of processors. The processor includes, for example, a central processing unit (CPU). The processing device 140 is an example of a computer in the present disclosure. Although details are explained below, the processing device 140 functions as a control center of the projection apparatus 10 by operating according to a program PR1 stored in advance in the storage device 130.

The projector 110 includes a light source (an internal light source), a generator that generates image light corresponding to image data provided from the processing device 140 and an optical system that guides the image light generated by the generator to the projection surface SC. In FIG. 1, the generator and the optical system are not illustrated. Specific examples of the generator include a drawing panel including a light modulation element such as a liquid crystal display (LCD), a liquid crystal on silicon (LCOS), or a digital micromirror device (DMD).

The camera 120 includes a CMOS or CCD image sensor. In the present embodiment, an imaging region of the camera 120 is set in advance to cover the entire projection surface SC. The camera 120 images the imaging region under the control by the processing device 140. The camera 120 outputs image data representing a captured image to the processing device 140.

The storage device 130 includes a nonvolatile memory such as a flash read-only memory (ROM) and a volatile memory such as a random-access memory (RAM). The nonvolatile memory of the storage device 130 stores the program PR1 for causing the processing device 140 to function as a control center of the projection apparatus 10. The nonvolatile memory of the storage device 130 is used by the processing device 140 as a work area when executing the program PR1. When a power supply (not illustrated in FIG. 1) of the projection apparatus 10 is turned on, the processing device 140 reads out the program PR1 from the nonvolatile memory to the volatile memory and starts executing the program PR1 read out to the volatile memory.

The processing device 140 operating according to the program PR1 functions as a first projection controller 140a, an imaging controller 140b, a detector 140c, a calculator 140d, and a second projection controller 140e.

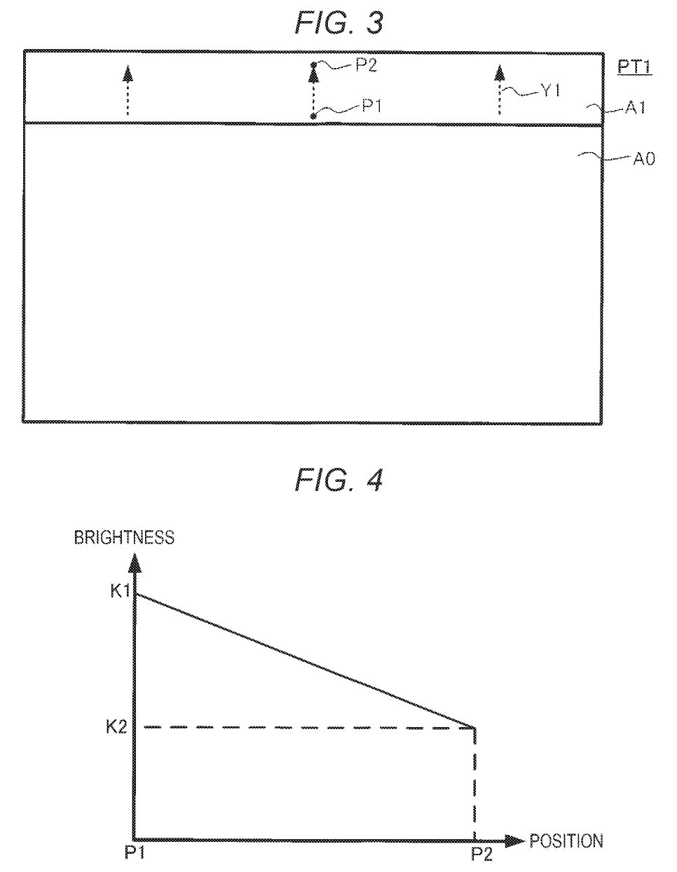

The first projection controller 140a causes the projector 110 to project a first pattern PT1 onto the projection surface in the first period. FIG. 3 is a diagram illustrating the first pattern PT1 in the present embodiment. As illustrated in FIG. 3, the first pattern PT1 in the present embodiment is an image including a first portion A0 and a strip-shaped second portion A1 provided above the first portion A0. The first portion A0 in the first pattern PT1 is entirely white and the brightness in the first portion A0 is uniform and constant.

In the second portion A1, the brightness continuously decreases in the first direction that is an example of a direction from the center of the projection surface SC to the outer side, that is, an edge of the projection surface SC. In other words, the second portion A1 appears blurred. In FIG. 3, the first direction is indicated by an arrow Y1. In the present embodiment, in the second portion A1, the brightness decreases from K1 to K2 in the first direction and, in FIG. 3, a state of the decrease is illustrated by drawing the arrow Y1 with a dotted line. FIG. 4 is a graph illustrating a gradient of decrease in brightness from a position P1 to a position P2 in FIG. 3. In the present embodiment, a ratio of the number of pixels of the second portion A1 to the number of pixels of the entire first pattern PT1 is approximately 5 to 10%. The first projection controller 140a draws, on the drawing panel in the projector 110, pattern data in which approximately 5 to 10% of the total number of pixels is the second portion A1 and the remaining pixels are the first portion A0 to thereby cause the projector 110 to project the first pattern PT1.

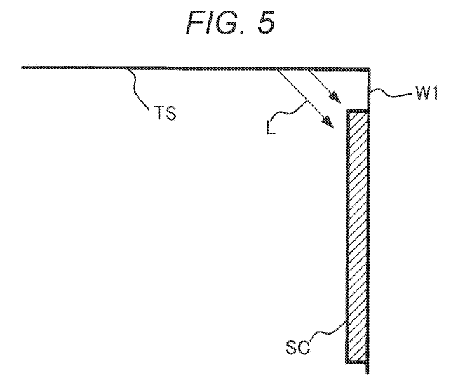

If it is attempted to detect corners of the projection surface SC (four corners of a rectangle corresponding to the contour of the projection surface SC) using an entirely white image, when the corners of the projection surface SC and another surface such as the ceiling TS are close, as illustrated in FIG. 5, the detection accuracy of corners close to the other surface sometimes decreases because of the influence of reflected light L of projection light by the other surface. The entirely white image means an image projected onto the projection surface SC by outputting white light from the entire drawing panel in the projector 110.

The first pattern PT1 is used to suppress the influence of the reflected light of the projection light by the other surface such that the corners can be detected even when the corners of the projection surface SC and the other surface such as a ceiling T are close to each other. In the present embodiment, as illustrated in FIG. 2, the projection surface SC is provided on the ceiling TS side of the wall W1, and there is a concern about the influence of the reflected light from the ceiling TS when the corners are detected. Therefore, in the present embodiment, the second portion A1 is provided above the first portion A0, that is, on the ceiling TS side. When there is a concern about the influence of reflected light from surfaces (the wall W2, the wall W3, and the floor surface BS) other than the ceiling TS, an image in which the annular second portion A1 is provided around the first portion A0 only has to be used as the first pattern PT1.

The first projection controller 140a stops the projection of the image light by the projector 110 following the projection of a first pattern in the first period to thereby display a second pattern on the projection surface SC. The second pattern in the present embodiment is an entirely black image. The entirely black image is an image based on ambient light in a room where the projection surface SC is installed. Since the ambient light includes leakage light from the projector 110, it can also be said that the second pattern is an image projected onto the projection surface SC by the projector 110. As another example of constructing an environment in which the projection surface SC onto which the entirely black image is projected is imaged, an aspect in which output of the light source of the projector 110 is reduced to zero or close to zero or an aspect in which a mechanical shutter provided in the projector 110 is closed may be adopted.

In a second period later than the first period, the first projection controller 140a causes the projector 110 to project the first pattern onto the projection surface and, subsequently, project the second pattern onto the projection surface SC following the projection of the first pattern.

The imaging controller 140b causes the camera 120 to capture the image of the projection surface SC and the first pattern projected onto the projection surface SC in the first period to thereby acquire first image data representing a first captured image. The imaging controller 140b causes the camera 120 to capture the image of the projection surface SC and the second pattern projected onto the projection surface SC in the first period to thereby acquire first reference image data representing a first reference image.

The imaging controller 140b causes the camera 120 to capture the image of the projection surface SC and the first pattern projected onto the projection surface SC in the second period to thereby acquire second image data representing a second captured image. The imaging controller 140b causes the camera 120 to capture the image of the projection surface SC and the second pattern projected onto the projection surface SC in the second period to thereby acquire second reference image data representing a second reference image.

The detector 140c detects, based on the first image data and the first reference image data, a plurality of first feature points which are marks indicating corners of the projection surface SC in the first captured image. A set of the plurality of first feature points in the present embodiment indicates edges appearing in the first captured image to correspond to a contour line of the projection surface SC. Each of the plurality of first feature points may be a natural feature point. In the present embodiment, for each pixel included in an image represented by the first image data, the detector 140c subtracts a pixel value of a pixel corresponding to the pixel in an image represented by the first reference image data to calculate a difference image indicating the difference between both the images. By this processing, noise in the surroundings is removed and only the influence due to the projection of the first pattern appears in the difference image. Subsequently, the detector 140c extracts a dark portion with respect to the difference image to thereby obtain information concerning a corner of the projection surface SC. Examples of processing of extracting a dark portion include local minimum value detection processing. The detector 140c in the present embodiment causes a differential filter of first derivative and a differential filter of second derivative to act on the difference image in each of an X direction (a horizontal scanning direction in the first captured image) and a Y direction (a vertical scanning direction) and detects a set of pixels in which "a result of the first derivative is equal to or smaller than a certain threshold" and "a result of the second derivative is equal to or larger than the certain threshold" as pixels corresponding to a corner of the projection surface SC. As the Y direction, a direction obtained by rotating the direction of a filter in the X direction by 90 degrees need only be used.

According to the present embodiment, a corner of the projection surface SC can be detected by the first pattern in which the brightness continuously decreases from the center of the projection surface SC toward the outer side, that is, the edge of the projection surface SC. The distribution in which the brightness continuously decreases is a distribution in a state in which the first pattern is projected onto the projection surface SC. Accordingly, at the corner of the projection surface SC and the vicinity thereof, the brightness becomes relatively lower than in the center of the projection surface and the influence of secondary reflection from a surface other than the projection surface SC is suppressed. Therefore, it is possible to suppress a decrease in the detection accuracy of a corner of the projection surface SC in the first period.

Based on the second image data and the second reference image data, the detector 140c detects a plurality of second feature points, which are marks indicating corners of the projection surface SC in the second captured image, with the same algorithm as the detection of the first feature points. The plurality of second feature points in the present embodiment indicate edges appearing in the second captured image to correspond to the contour of the projection surface SC. It is possible to suppress a decrease in the detection accuracy of a corner of the projection surface SC in the second period.

The calculator 140d calculates, based on a plurality of first feature points detected by the detector 140c and a plurality of second feature points detected by the detector 140c, correction data for correcting a projection image projected onto the projection surface SC in the second period. Specifically, the calculator 140d calculates, as the correction data, data representing a transformation matrix for transforming the positions on the drawing panel of four corners of a rectangle, a contour of which is represented by the plurality of second feature points into the positions on the drawing panel of four corners of a rectangle, a contour of which is represented by the plurality of first feature points. According to the present embodiment, since the correction data is calculated based on a detection result of a corner in which a decrease in accuracy is suppressed, the accuracy of correcting an image is improved. The correction data in the present embodiment is data for adjusting the position of a projection image with respect to the projection surface SC in the second period to the position of a projection image with respect to the projection surface SC in the first period. According to the present embodiment, since the position of an image can be corrected based on a detection result of the corner in which a decrease in accuracy is suppressed, the accuracy of correcting the position of an image is improved.

The second projection controller 140e causes the projector 110 to project the projection image while correcting the position with respect to the projection surface SC based on the correction data calculated by the calculator 140d.

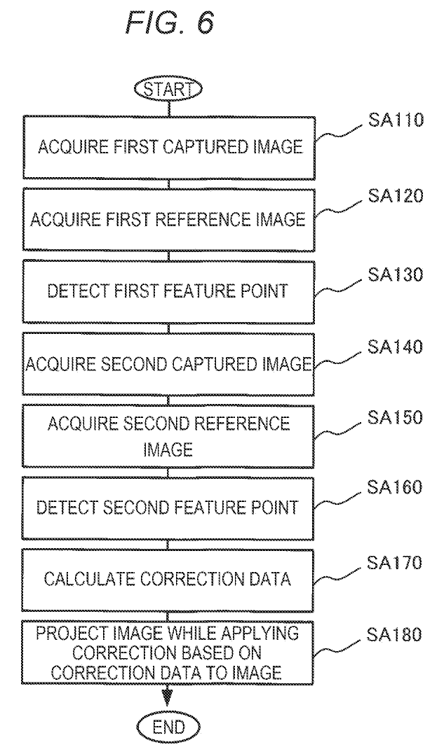

The processing device 140 operating according to the program PR1 executes a control method that conspicuously shows characteristics of the present disclosure. FIG. 6 is a flowchart illustrating a flow of processing in the control method. Processing in step SA110, step SA120, and step SA130 is processing executed in the first period. Processing in step SA140 and subsequent steps are processing executed in the second period.

In step SA110, the processing device 140 functions as the first projection controller 140a and the imaging controller 140b. In step SA110, first, the processing device 140 causes the projector 110 to project the first pattern PT1 onto the projection surface SC. The processing device 140 in a state of projecting the first pattern PT1 onto the projection surface SC further functions as the imaging controller 140b and causes the camera 120 to capture the image of the projection surface SC and the first pattern PT1 projected onto the projection surface SC in the first period to acquire the first image data representing the first captured image.

Also in step SA120 executed following step SA110, the processing device 140 functions as the first projection controller 140a and the imaging controller 140b. In step SA120, first the processing device 140 causes the projector 110 to project the second pattern onto the projection surface SC. The processing device 140 that is causing the projector 110 to project the second pattern onto the projection surface further functions as the imaging controller 140b and causes the camera 120 to capture the image of the projection surface SC and the second pattern projected onto the projection surface SC to acquire the first reference image data representing the first reference image.

In step SA130, the processing device 140 functions as the detector 140c. In step SA130, the processing device 140 detects a plurality of first feature points based on the first image data and the first reference image data.

In step SA140, the processing device 140 functions as the first projection controller 140a and the imaging controller 140b. In step SA140, the processing device 140 causes the projector 110 to project the first pattern PT1 onto the projection surface SC. The processing device 140 that is causing the projector 110 to project the first pattern PT1 onto the projection surface SC further functions as the imaging controller 140b and causes the camera 120 to capture the image of the projection surface SC and the first pattern PT1 projected onto the projection surface SC in the second period to acquire the second image data representing the second captured image.

In step SA150 following step SA140, the processing device 140 causes the projector 110 to project the second pattern onto the projection surface SC. The processing device 140 that is causing the projector 110 to project the second pattern onto the projection surface SC further functions as the imaging controller 140b and causes the camera 120 to capture the image of the projection surface SC and the second pattern projected onto the projection surface SC to thereby acquire the second reference image data representing the second reference image.

In step SA160 following step SA150, the processing device 140 functions as the detector 140c. In step SA160, the processing device 140 detects a plurality of second feature points based on the second image data and the second reference image data.

In step SA170 following step SA160, the processing device 140 functions as the calculator 140d. In step SA170, the processing device 140 calculates, based on the plurality of first feature points detected in step SA130 and the plurality of second feature points detected in step SA160, correction data for adjusting the position of a projection image projected onto the projection surface in the second period with respect to the projection surface to the position of the projection image with respect to the projection surface in the first period.

In step SA180 following step SA170, the processing device 140 functions as the second projection controller 140e. In step SA180, the processing device 140 causes the projector 110 to project the projection image while correcting the position with respect to the projection surface SC based on the correction data calculated in step SA170.

As explained above, according to the present embodiment, since an edge of the projection surface can be detected by the first pattern in which the brightness continuously decreases from the center of the projection surface toward the outer side, that is, the edge of the projection surface, the influence of secondary reflection from a surface other than the projection surface is suppressing from reaching the edge and the vicinity thereof. It is possible to prevent the accuracy of detecting an edge in each of the first period and the second period from decreasing. In the present embodiment, a mark such as a marker indicating the position of the projection surface is unnecessary. An edge of the projection surface SC can be detected without a marker even when it is difficult to detect the edge under a condition in which walls around the edge of the projection surface SC are seen in substantially the same color. Further, in the present embodiment, since the edge of the projection surface SC can be detected by projecting the two patterns of the first pattern and the second pattern as the projection pattern, there is also an effect that a time required for detecting the edge is short.

In addition, according to the present embodiment, since the correction data is calculated based on the detection result of the edge in which the decrease in accuracy is suppressed, the accuracy of correcting an image is improved. Since the correction data in the present embodiment is data for adjusting the position of the projection image with respect to the projection surface in the second period to the position of the projection image with respect to the projection surface in the first period, the accuracy of correcting the position of an image in the second period is improved.

### B. Second Embodiment

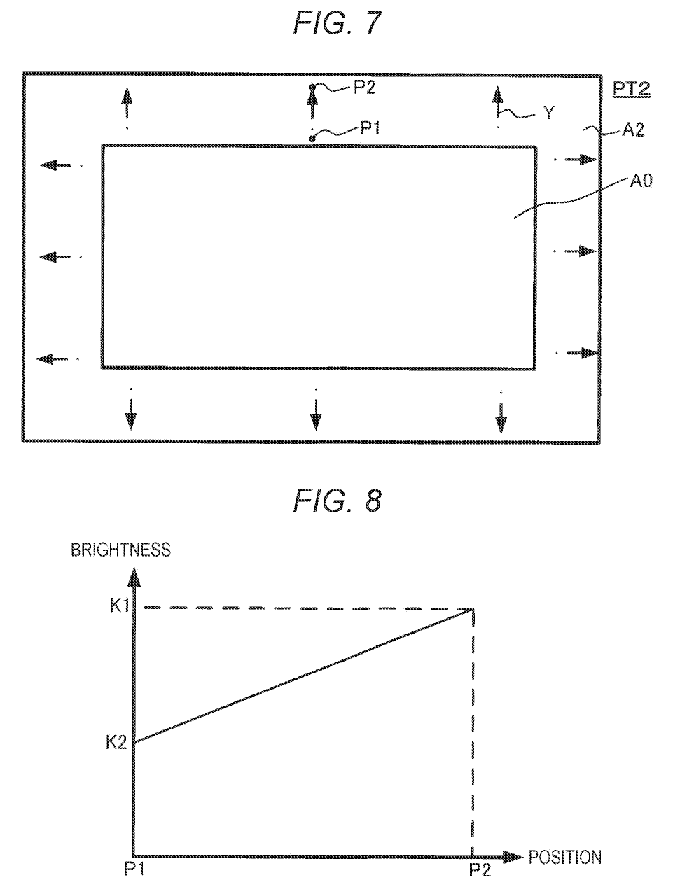

Subsequently, a second embodiment of the present disclosure is explained. In the projection apparatus 10 in the second embodiment, a first pattern PT2 projected onto the projection surface SC in the first period and the second period is different from the first pattern PT1 in the first embodiment. FIG. 7 is a diagram illustrating an example of the first pattern PT2 projected by the projection apparatus 10 in the present embodiment. As it is evident if FIGS. 3 and 7 are compared, the first pattern PT2 in the present embodiment has a first portion A0 and an annular second portion A2 provided around the first portion A0. At least the first portion A0 is an example of a portion of an image to be projected and the second portion A2 is an example of the outer side of the image. That is, the annular second portion A2 is disposed on the outer side of the image. FIG. 8 is a graph illustrating a state in which the brightness from the position P1 to the position P2 in the first direction in the second portion A2 increases from K2 to K1. As illustrated in FIG. 8, in the second portion A2, the brightness continuously increases in a first direction that is a direction from the center of the projection surface SC to the outer side, that is, an edge of the projection surface SC. In FIG. 7, a state in which the brightness continuously increases in the first direction from the center of the projection surface SC to the outside, that is, the edge of the projection surface SC in the second portion A2 is indicated by an arrow Y2 drawn by an alternate long and short dash line. By causing the projection apparatus 10 to project the first pattern PT2 such that the projection surface SC fits in the first portion A0 in the second pattern in the present embodiment, it is possible to reduce the influence of reflected light from another surface located in the vicinity of a corner of the projection surface SC as in the embodiment explained above.

According to the present embodiment as well, since an edge of the projection surface can be detected by using the first pattern PT2 in which the brightness continuously increases from the center of the projection surface toward the outer side, that is, the edge of the projection surface, the influence of secondary reflection from a surface other than the projection surface is suppressing from reaching the edge and the vicinity thereof. It is possible to prevent a decrease in the accuracy of detecting the edge in each of the first period and the second period. In the present embodiment as well, since the correction data is calculated based on a detection result of an edge in which a decrease in accuracy is suppressed, the accuracy of correcting an image is improved. Like the correction data in the first embodiment, the correction data in the present embodiment is data for adjusting the position of the projection image with respect to the projection surface in the second period to the position of the projection image with respect to the projection surface in the first period. Therefore, according to the present embodiment as well, the accuracy of correcting the position of an image in the second period is improved.

### C. Modifications

The embodiments explained above can be modified as explained below.

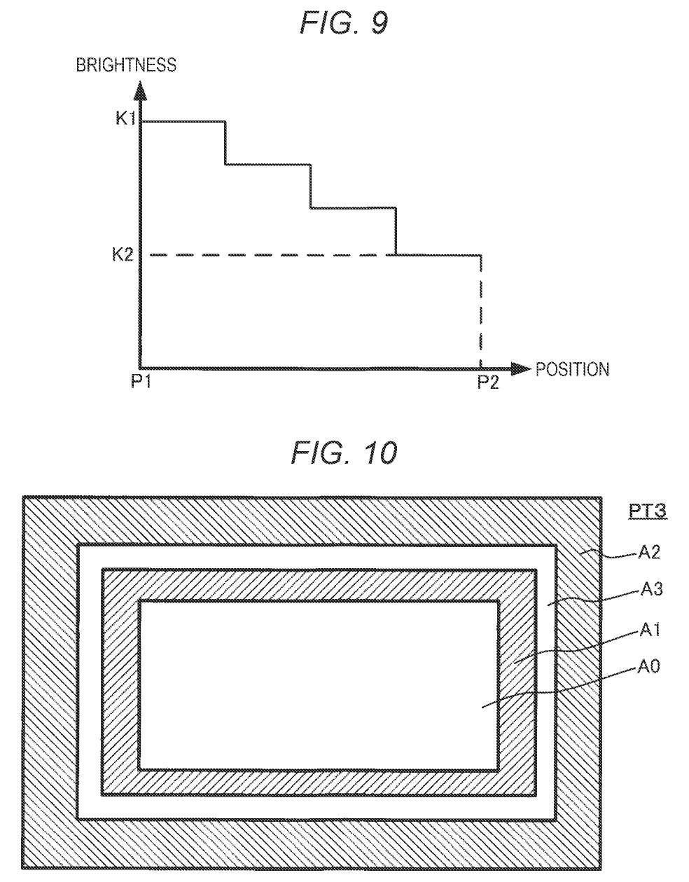

(1) In the second portion A1 of the second pattern in the first embodiment, as illustrated in FIG. 4, the brightness continuously decreases in the first direction from the position P1 to the position P2. However, as illustrated in FIG. 9, an image having the second portion A1 in which the brightness decreases stepwise from K1 to K2 in the first direction from the position P1 to the position P2 may be used as the first pattern. By using the first pattern in which the brightness decreases stepwise from the center of the projection surface toward the outer side, that is, the edge of the projection surface, the influence of the secondary reflection from the surface other than the projection surface is suppressing from reaching a corner of the projection surface SC and the vicinity thereof. Similarly, for the second portion A2 in the second embodiment, the brightness may increase stepwise from the position P1 to the position P2 in the first direction.

(2) As illustrated in FIG. 10, a first pattern PT3 including the second portion A1 and the second portion A2 may be used and the first pattern PT3 may be projected to sandwich a corner of the projection surface SC in a region A3 between the second portion A1 and the second portion A2. According to this aspect as well, the influence of secondary reflection from a surface (for example, a ceiling) other than the projection surface is suppressing from reaching a corner of the projection surface and the vicinity thereof. The size of the region A3 can also be adjusted according to a positional relationship between the projection surface SC and the surface other than the projection surface SC.

(3) The first pattern PT1 in the first embodiment is the entirely white image having the second portion A2 in the periphery but may be a single-color image of any one of R, G, and B having the second portion A2 in the periphery. By using the first pattern PT1 having a color (for example, a color having a complementary color relationship) corresponding to a color of the wall surface of the room in which the projection surface is installed, it is expected that the influence of the secondary reflection from the surface other than the projection surface can be further suppressing from reaching the corner of the projection surface SC and the vicinity thereof. The same applies to the first pattern PT2 in the second embodiment. When the single-color image of any one of R, G, and B having the second portion A2 in the periphery thereof is used as the first pattern PT1, the detector 140c may use a different differential filter depending on the color of the image.

(4) The distribution of the second portion A1 in the first pattern PT1 may be changed. The changing the distribution of the second portion A1 means changing a range (that is, the size) of the second portion A1 or changing a gradient of a change in brightness in the second portion A1. As the second portion A2 is larger and the gradient of the brightness change is gentler, a margin with which the position of a projection image with respect to the projection surface SC can be maintained is wider. On the other hand, when the gradient of the brightness change is steep, it is easy to find a corner of the projection surface SC. The projection surface SC onto which the first pattern PT1 is projected may be imaged using the camera 120 and the differential filter of the detector 140c may be changed according to at least one of a range and a gradient of distribution of the second portion A1 in a captured image. Similarly, the distribution of the second portion A2 may be changed in the first pattern PT2 in the second embodiment.

(5) The first projection controller 140a, the imaging controller 140b, the detector 140c, the calculator 140d, and the second projection controller 140e in the embodiments explained above are the software modules. However, at least one of the first projection controller 140a, the imaging controller 140b, the detector 140c, the calculator 140d, and the second projection controller 140e may be a hardware module such as an application specific integrated circuit (ASIC). Even when at least one of the first projection controller 140a, the imaging controller 140b, the detector 140c, the calculator 140d, and the second projection controller 140e is the hardware module, the same effects as those of the embodiments explained above are achieved.

(6) The first pattern in the embodiments explained above is used to generate the correction data for adjusting the position of the projection image with respect to the projection surface SC in the second period to the position of the projection image with respect to the projection surface SC in the first period. However, the first pattern may be used for shape correction for matching the shape of an image with an edge of the projection surface SC.

(7) The program PR1 may be provided alone and may be provided for a fee or free of charge. Specific aspects at the time when providing the program PR1 include an aspect in which the program PR1 is provided by being written in a computer-readable recording medium such as a flash ROM and an aspect in which the program PR1 is provided by being downloaded through an electric communication line such as the Internet.

### D. Summary of the present disclosure

The present disclosure is not limited to the embodiment and the modifications explained above and can be implemented in various aspects without departing from the gist of the present disclosure. For example, the present disclosure can also be implemented by the following aspects. The technical characteristics in the embodiment explained above corresponding to technical characteristics in the aspects described below can be replaced or combined as appropriate in order to solve a part or all of the problems of the present disclosure or in order to achieve a part or all of the effects of the present disclosure. The technical characteristics can be deleted as appropriate unless explained as essential technical characteristics in the present specification.

A summary of the present disclosure is appended below.

### Appendix 1

According to an aspect of the present disclosure, there is provided a control method for a projection system including a projector configured to project an image onto a projection surface, a camera, and one or a plurality of processors configured to control the projector and the camera, the control method executing, with the one or the plurality of processors: causing, in a first period, the projector to project, onto the projection surface, a first pattern in which brightness decreases continuously or stepwise in a direction from a center of the projection surface toward an edge of the projection surface; acquiring a first captured image by causing the camera to capture the projection surface and the first pattern projected onto the projection surface in the first period; and detecting a plurality of first feature points indicating edges of the projection surface in the first captured image. With the control method of this aspect, an edge of the projection surface can be detected by the first pattern in which the brightness decreases continuously or stepwise from the center of the projection surface toward the edge of the projection surface. Accordingly, at the edge of the projection surface and the vicinity thereof, the brightness becomes relatively lower than in the center of the projection surface and the influence of secondary reflection from a surface other than the projection surface can be suppressing from reaching the edge and the vicinity thereof. Therefore, it is possible to prevent the accuracy of detecting the edge from decreasing.

### Appendix 2

According to another aspect of the present disclosure, there is provided a control method for a projection system including a projector configured to project an image onto a projection surface, a camera, and one or a plurality of processors configured to control the projector and the camera, the control method executing, with the one or the plurality of processors: causing, in a first period, the projector to project, onto the projection surface, a first pattern in which brightness increases continuously or stepwise in a direction from a center of the projection surface toward an edge of the projection surface, the first pattern being annular and disposed on an outer side of the image; acquiring a first captured image by causing the camera to capture the projection surface and the first pattern projected onto the projection surface in the first period; and detecting a plurality of first feature points indicating edges of the projection surface in the first captured image. With the control method of this aspect, the edge of the projection surface can be detected by the first pattern in which the brightness continuously or stepwise increases from the center of the projection surface toward the edge of the projection surface, the first pattern being annular and provided on the outer side of the image. Accordingly, at the edge of the projection surface and the vicinity thereof, the brightness becomes relatively lower than in the center of the projection surface and the influence of secondary reflection from a surface other than the projection surface can be suppressing from reaching the edge and the vicinity thereof. Therefore, it is possible to prevent the accuracy of detecting the edge from decreasing.

### Appendix 3

A control method according to a more preferable aspect is the control method described in Appendix 1 or Appendix 2, further executing, with the one or the plurality of processors: causing, in a second period later than the first period, the projector to project the first pattern onto the projection surface; causing the camera to capture the image of the projection surface and the first pattern projected onto the projection surface in the second period to acquire a second captured image; detecting a plurality of second feature points indicating edges of the projection surface in the second captured image; calculating, based on the plurality of first feature points and the plurality of second feature points, correction data for correcting the image; and causing the projector to project the image corrected based on the correction data onto the projection surface. With the control method of this aspect, since the image can be corrected based on a detection result of the edge in which the decrease in accuracy is suppressed, the accuracy of correcting the image is also improved.

### Appendix 4

A control method according to a more preferable aspect is the control method described in Appendix 3, wherein the correction data is data for adjusting a position of the image with respect to the projection surface in the second period to a position of the image with respect to the projection surface in the first period. With the control method of this aspect, since the position of the image can be corrected based on a detection result of the edge in which the decrease in accuracy is suppressed, the accuracy of correcting the position of the image is also improved.

### Appendix 5

A control method according to a more preferable aspect is the control method described in any one of Appendix 1, Appendix 2, Appendix 3, and Appendix 4, further including receiving operation of adjusting a distribution of brightness in the first direction, wherein the causing the projector to project the first pattern onto the projection surface in the first period includes projecting the first pattern adjusted based on the operation in the first period onto the projection surface, and the acquiring the first captured image includes acquiring the first captured image by causing the camera to capture the image of the projection surface and the first pattern adjusted based on the operation and projected onto the projection surface in the first period. According to this aspect, for example, the plurality of first feature points optimized for the shape of the projection surface, an installation environment, and the like can be detected by the first pattern having the distribution of brightness adjusted considering the shape of the projection surface, the installation environment, and the like.

### Appendix 6

According to an aspect of the present disclosure, there is provided a projection apparatus including: a projector configured to project an image onto a projection surface; and one or a plurality of processors, the one or the plurality of processors executing: causing, in a first period, the projector to project, onto the projection surface, a first pattern in which brightness decreases continuously or stepwise in a first direction that is a direction from a center of the projection surface toward an edge of the projection surface; causing a camera to capture the image of the projection surface and the first pattern projected onto the projection surface in the first period to acquire a first captured image; and detecting a plurality of first feature points indicating edges of the projection surface in the first captured image. With the projection apparatus of this aspect, as in the control method described in Appendix 1, an edge of the projection surface can be detected by the first pattern in which the brightness decreases continuously or stepwise from the center of the projection surface toward the edge of the projection surface. Accordingly, at the edge of the projection surface and the vicinity thereof, the brightness becomes relatively lower than in the center of the projection surface and the influence of secondary reflection from a surface other than the projection surface can be suppressing from reaching the edge and the vicinity thereof. Therefore, it is possible to prevent the accuracy of detecting the edge from decreasing.

### Appendix 7

According to another aspect of the present disclosure, there is provided a projection apparatus including: a projector configured to project an image onto a projection surface; and one or a plurality of processors, the one or the plurality of processors executing: causing, in a first period, the projector to project, onto the projection surface, a first pattern in which brightness increases continuously or stepwise in a direction from a center of the projection surface toward an edge of the projection surface, the first pattern being annular and disposed on an outer side of the image; causing a camera to capture the image of the projection surface and the first pattern projected onto the projection surface in the first period to acquire a first captured image, and detecting a plurality of first feature points indicating edges of the projection surface in the first captured image. With the projection apparatus of this aspect, as in the control method described in Appendix 2, the edge of the projection surface can be detected by the first pattern in which the brightness continuously or stepwise increases from the center of the projection surface toward the edge of the projection surface, the first pattern being annular and provided on the outer side of the image. Accordingly, at the edge of the projection surface and the vicinity thereof, the brightness becomes relatively lower than in the center of the projection surface and the influence of secondary reflection from a surface other than the projection surface can be suppressing from reaching the edge and the vicinity thereof. Therefore, it is possible to prevent the accuracy of detecting the edge from decreasing.

### Appendix 8

According to an aspect of the present disclosure, there is provided a non-transitory computer-readable storage medium storing a program, the program causing a computer, which controls a projector configured to project an image onto a projection surface and a camera, to execute: causing, in a first period, the projector to project, onto the projection surface, a first pattern in which brightness decreases continuously or stepwise in a first direction that is a direction from a center of the projection surface toward an edge of the projection surface; acquiring a first captured image by causing the camera to capture the projection surface and the first pattern projected onto the projection surface in the first period; and detecting a plurality of first feature points indicating edges of the projection surface in the first captured image. With the non-transitory computer-readable storage medium storing the program of this aspect, as in the control method described in Appendix 1, an edge of the projection surface can be detected by the first pattern in which the brightness decreases continuously or stepwise from the center of the projection surface toward the edge of the projection surface. Accordingly, at the edge of the projection surface and the vicinity thereof, the brightness becomes relatively lower than in the center of the projection surface and the influence of secondary reflection from a surface other than the projection surface can be suppressing from reaching the edge and the vicinity thereof. Therefore, it is possible to prevent the accuracy of detecting the edge from decreasing.

### Appendix 9

According to another aspect of the present disclosure, there is provided a non-transitory computer-readable storage medium storing a program, the program causing a computer, which controls a projector configured to project an image onto a projection surface and a camera, to execute: causing, in a first period, the projector to project, onto the projection surface, a first pattern in which brightness increases continuously or stepwise in a direction from a center of the projection surface toward an edge of the projection surface, the first pattern being annular and provided on an outer side of the image; acquiring a first captured image by causing the camera to capture the projection surface and the first pattern projected onto the projection surface in the first period; and detecting a plurality of first feature points indicating edges of the projection surface in the first captured image. With the non-transitory computer-readable storage medium storing the program of this aspect, as in the control method described in Appendix 2, the edge of the projection surface can be detected by the first pattern in which the brightness continuously or stepwise increases from the center of the projection surface toward the edge of the projection surface, the first pattern being annular and provided on the outer side of the image. Accordingly, at the edge of the projection surface and the vicinity thereof, the brightness becomes relatively lower than in the center of the projection surface and the influence of secondary reflection from a surface other than the projection surface can be suppressing from reaching the edge and the vicinity thereof. Therefore, it is possible to prevent the accuracy of detecting the edge from decreasing.

What is claimed is:

1. A control method for a projection system including a projector configured to project an image onto a projection surface, a camera, and one or a plurality of processors configured to control the projector and the camera, the control method executing, with the one or the plurality of processors:
causing, in a first period, the projector to project, onto the projection surface, a first pattern in which brightness decreases continuously or stepwise in a direction from a center of the projection surface toward an edge of the projection surface;
acquiring a first captured image by causing the camera to capture the projection surface and the first pattern projected onto the projection surface in the first period; and
detecting a plurality of first feature points indicating edges of the projection surface in the first captured image.

2. A control method for a projection system including a projector configured to project an image onto a projection surface, a camera, and one or a plurality of processors configured to control the projector and the camera, the control method executing, with the one or the plurality of processors:
causing, in a first period, the projector to project, onto the projection surface, a first pattern in which brightness increases continuously or stepwise in a direction from a center of the projection surface toward an edge of the projection surface, the first pattern being annular and disposed on an outer side of the image;
acquiring a first captured image by causing the camera to capture the projection surface and the first pattern projected onto the projection surface in the first period; and
detecting a plurality of first feature points indicating edges of the projection surface in the first captured image.

3. The control method according to claim 1, further executing, with the one or the plurality of processors:
causing, in a second period later than the first period, the projector to project the first pattern onto the projection surface;
acquiring a second captured image by causing the camera to capture the projection surface and the first pattern projected onto the projection surface in the second period;
detecting a plurality of second feature points indicating edges of the projection surface in the second captured image;
calculating, based on the plurality of first feature points and the plurality of second feature points, correction data for correcting the image; and
causing the projector to project the image corrected based on the correction data onto the projection surface.

4. The control method according to claim 3, wherein the correction data is data for adjusting a position of the image with respect to the projection surface in the second period to a position of the image with respect to the projection surface in the first period.

5. The control method according to claim 1, further executing, with the one or the plurality of processors, receiving operation of adjusting a distribution of brightness in the first direction, wherein
the causing the projector to project the first pattern onto the projection surface in the first period includes projecting the first pattern adjusted based on the operation in the first period onto the projection surface, and
the acquiring the first captured image includes acquiring the first captured image by causing the camera to capture the projection surface and the first pattern adjusted based on the operation and projected onto the projection surface in the first period.

6. A projection apparatus comprising:
a projector configured to project an image onto a projection surface;
one or a plurality of processors; and
a camera,
the one or the plurality of processors executing:
causing, in a first period, the projector to project, onto the projection surface, a first pattern in which brightness decreases continuously or stepwise in a first direction that is a direction from a center of the projection surface toward an edge of the projection surface;
acquiring a first captured image by causing the camera to capture the projection surface and the first pattern projected onto the projection surface in the first period; and
detecting a plurality of first feature points indicating edges of the projection surface in the first captured image.

7. A projection apparatus comprising:
a projector configured to project an image onto a projection surface;
one or a plurality of processors; and
a camera,
the one or the plurality of processors executing: causing, in a first period, the projector to project, onto the projection surface, a first pattern in which brightness increases continuously or stepwise in a direction from a center of the projection surface toward an edge of the projection surface, the first pattern being annular and disposed on an outer side of the image;
acquiring a first captured image by causing the camera to capture the projection surface and the first pattern projected onto the projection surface in the first period; and
detecting a plurality of first feature points indicating edges of the projection surface in the first captured image.

8. A non-transitory computer-readable storage medium storing a program, the program causing a computer, which controls a projector configured to project an image onto a projection surface and a camera, to execute:
causing, in a first period, the projector to project, onto the projection surface, a first pattern in which brightness decreases continuously or stepwise in a first direction that is a direction from a center of the projection surface toward an edge of the projection surface;
acquiring a first captured image by causing the camera to capture the projection surface and the first pattern projected onto the projection surface in the first period; and
detecting a plurality of first feature points indicating edges of the projection surface in the first captured image.

9. A non-transitory computer-readable storage medium storing a program, the program causing a computer, which controls a projector configured to project an image onto a projection surface and a camera, to execute:
causing, in a first period, the projector to project, onto the projection surface, a first pattern in which brightness increases continuously or stepwise in a direction from a center of the projection surface toward an edge of the projection surface, the first pattern being annular and provided on an outer side of the image;
acquiring a first captured image by causing the camera to capture the projection surface and the first pattern projected onto the projection surface in the first period; and
detecting a plurality of first feature points indicating edges of the projection surface in the first captured image.
